(19) United States
(12) Patent Application Publication
(10) Pub. No.: US 2012/0081756 A1
(43) Pub. Date: Apr. 5, 2012

(54) MIRROR SUPPORT DEVICE AND IMAGE READER

(76) Inventor: NAMIE SUGIYAMA, Shizuoka (JP)

(21) Appl. No.: 13/198,335

(22) Filed: Aug. 4, 2011

(30) Foreign Application Priority Data
Oct. 1, 2010 (JP) 2010-223623

(51) Int. Cl. H04N 1/23; G02B 7/182

(52) U.S. Cl. 358/296; 359/871

(57) ABSTRACT

A mirror support device arranged in both ends of a stick-like mirror for holding the mirror including an inner side plate, comprising a mirror insertion opening formed in the inner side plate, the mirror insertion opening for inserting an end of a mirror; an outer side plate connected to the inner side plate, comprising: a mirror stopper plate for regulating positions of a right and a left end face of the mirror inserted into the mirror insertion opening; and a clip hole, the mirror stopper plate and the clip hole being formed in the outer side plate; and a clip for fixing the mirror, the clip being inserted into the clip hole from a same direction as inserting direction of the mirror.

This application is based upon and claims the benefit of priority from Japanese Patent Application No. 2010-223623, filed on Oct. 1, 2010, the disclosure of which is incorporated herein in its entirety by reference.

### TECHNICAL FIELD

The present invention relates to a mirror support device and an image reader.

### BACKGROUND ART

An image reader has optical components such as a mirror and a lens for applying light to an original placed on a contact glass and leading reflected light from the original toward a predetermined direction. Such optical components are supported by an optical unit that travels in the main scanning directions. On this occasion, a vibration, a positional displacement and the like (hereinafter, simply referred to as a vibration) may occur in the optical components due to a vibration of the optical unit. A vibration of the optical components will be a cause of degradation of the image reading accuracy. Accordingly, such vibration needs to be regulated, and thus various holding structures have been proposed.

For example, Japanese Patent application Laid-Open No. 11-052494 (hereinafter, referred to as a first related technology) discloses a mirror holding structure as shown in FIG. 11. FIG. 11 is a fragmentary sectional view of the mirror holding structure. The mirror holding structure holds a mirror 102 in a mirror holding member 103 by a clip 101. That is, the mirror 102 is inserted into a mirror attaching portion 104 of a through hole shape formed in the mirror holding member 103 of a plate-like shape. Then, the clip 101 of a nearly V-letter shape is inserted between a back face 102b of the mirror 102 and the mirror attaching portion 104 from a side direction of the mirror 102. As a result, by an elastic force of the clip 101, the mirror 102 is biased to the side of a mirror surface 102a and held in the mirror attaching portion 104.

Japanese Patent Application Laid-Open No. 2007-199218 (hereinafter, referred to as a second related technology) discloses a mirror holding structure as shown in FIG. 12. FIG. 12 is a fragmentary sectional view of the mirror holding structure. In this mirror holding structure, a mirror 112 is inserted into a mirror attaching portion 114 formed in a plate-like mirror holding member 113. In this state, a clip 111 is installed into the mirror holding member 113 from a side direction of the mirror 112 and the mirror 112 is held. The clip 111 is formed like an almost C-letter shape. An one end 111a of the clip 111 is inserted into an engaging hole 115 formed in the mirror holding member 113, and an other end 111b is applied to a back face 112b of the mirror 112. By this, the mirror 112 is held by an elastic force of the clip 111.

Further, Japanese Patent Application Laid-Open No. 2007-078104 (hereinafter, referred to as a third related technology) discloses a mirror holding mechanism as shown in FIG. 13. FIG. 13 is a fragmentary sectional view of the mirror holding structure. In this mirror holding mechanism, a mirror 123 is placed on an attaching member 121 including a seat surface 122a and a back surface 122b. An one end 124a of the clamp 124 is in contact with the mirror 123, and an other end 124b is engaged with the attaching member 121. As a result, the mirror 123 is pressed toward the back surface 122b side. In addition, a suppressor segment 124c is formed in the clamp 124 by clipping work. When the one end 124a of the clamp 124 is made be in contact with the mirror 123, the suppressor segment 124c pushes the mirror 123 towards the side of the seat surface 122a. By this, the mirror 123 is held.

However, in the mirror holding mechanisms according to the first and second related technologies, there are following problems. That is, when the mirror 102 and 112 are inserted into the mirror holding members 103 and 113, respectively, worker's posture position is a position in front of the mirror. However, when the clips 101, 111 are installed, a worker needs to change the work posture toward a side of the mirrors 102, 112. Accordingly, because installation work of the mirrors 102, 112 and the clips 101, 111 cannot be performed as a series of work, there is a problem that the work efficiency declines.

Also, in order to install the clips 101, 111 smoothly, a worker sometimes opens the clip 101, 111 widely to install them. When the clips 101, 111 are opened more than necessary, the clips 101, 111 cause plastic deformation and cannot hold the mirrors 102, 112 with enough power any more. Accordingly, the mirrors 102, 112 vibrate easily.

Further, the clips 101, 111 need to be removed in maintenance or the like. On this occasion, there is a case where the clips 101, 111 are widely opened, causing plastic deformation. In this case, reuse of the clips 101, 111 becomes impossible.

On the other hand, in the mirror holding mechanism according to the third related technology, there is a risk that, if the clamp 124 is compressed too much, the mirror 123 is tilted when the clamp 124 is restored by an elastic force. The clamp 124 expressed in a solid line in FIG. 13 indicates the clamp 124 inserted into the proper position. The clamp 124 expressed in a dotted line indicates the clamp 124 compressed too much. Hereinafter, the position of the clamp 124 indicated by a dotted line is described as an excessively compressed state.

The excessively compressed state is a state that the one end 124a and the suppressor segment 124c of the clamp 124 are exhibiting large elastic deformation. For this reason, when a worker releases his hand from the clamp 124, there is a case where the mirror 123 is tilted by restoring force of the one end 124a and the suppressor segment 124c of the clamp 124. That is, restoring force of such as the one end 124a of the clamp 124 has a force component F applied to the mirror 123 in parallel with a mirror surface 123a. Due to this force component F, the mirror 123 comes to rotate about a corner 122c of the back surface 122b of the attaching member 121, taking the corner as the rotation axis. FIG. 14 is a side view of the mirror holding mechanism indicating a state that the mirror has been tilted by the force component F parallel to the mirror surface 123a. Because the state that the mirror 123 is tilted as shown in FIG. 14 is a state that the mirror 123 is balanced at a metastable point, when a vibration is added from outside, the mirror 123 easily vibrates and changes its position.

### SUMMARY

A main object of the present invention is to provide a mirror support device and an image reader in which mirror support work can be performed efficiently and a mirror can be supported stably.

A mirror support device arranged in both ends of a stick-like mirror for holding the mirror including an inner side plate, comprising a mirror insertion opening formed in the inner side plate, the mirror insertion opening for inserting an end of a mirror; an outer side plate connected to the inner side plate, comprising: a mirror stopper plate for regulating positions of a right and a left end face of the mirror inserted into the mirror insertion opening; and a clip hole, the mirror stopper plate and the clip hole being formed in the outer side plate; and a clip for fixing the mirror, the clip being inserted into the clip hole from a same direction as inserting direction of the mirror.

### BRIEF DESCRIPTION OF THE DRAWINGS

Exemplary features and advantages of the present invention will become apparent from the following detailed description when taken with the accompanying drawings in which:

FIG. 1 is a perspective view of an image forming apparatus according to an exemplary embodiment of the present invention;

FIG. 2 is a perspective view of an optical unit;

FIG. 3 is a perspective view of a mirror support device;

FIG. 4A is a perspective view of a clip seen from the back;

FIG. 4B is a perspective view of the clip seen from the front;

FIG. 4C is a side view of the clip;

FIG. 5 is a partial exploded perspective view of a supporting plate;

FIG. 6 is a fragmentary perspective view of a mirror support device at the time of starting insertion of the mirror;

FIG. 7 is a fragmentary sectional view of a mirror support device at the time of starting insertion of a clip;

FIG. 8 is a fragmentary sectional view of a mirror support device in the state that a locking plate is in contact with a clip supporting plate;

FIG. 9 is a fragmentary sectional view of a mirror support device of the state that the locking plate is positioned in a portion lower than the clip supporting plate;

FIG. 10 is a fragmentary sectional view of a mirror support device of the state that a clip is compressed to the maximum amount;

FIG. 11 is a fragmentary sectional view of a mirror support device according to the first related technology;

FIG. 12 is a fragmentary sectional view of a mirror support device according to the second related technology;

FIG. 13 is a fragmentary sectional view of a minor support device according to the third related technology; and

FIG. 14 is a fragmentary sectional view of a mirror support device illustrating a problem in the third related technology.

### EXEMPLARY EMBODIMENT

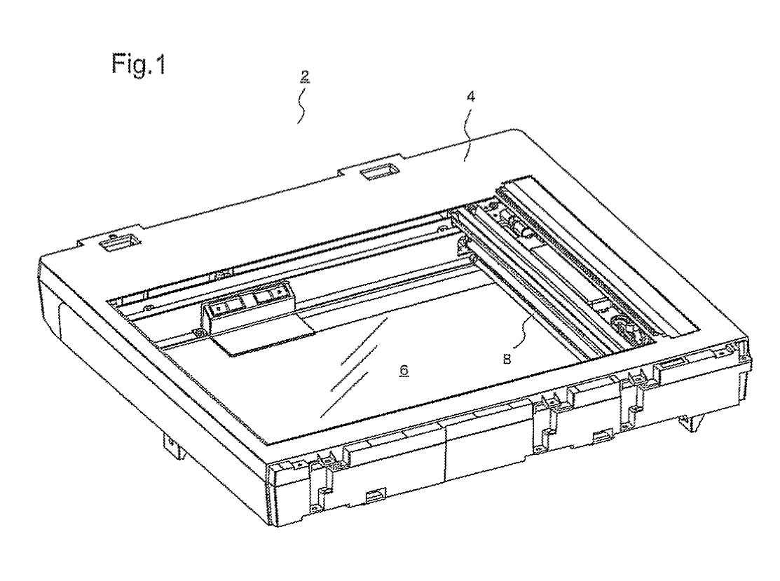

An exemplary embodiment of the present invention will be described. FIG. 1 is a fragmentary perspective view of an image reader 2 including a mirror support device. The image reader 2 has a box-like case 4, a contact glass 6 provided in the upper surface of the case 4 and an optical unit 8 provided in a portion in the case 4 below the contact glass 6.

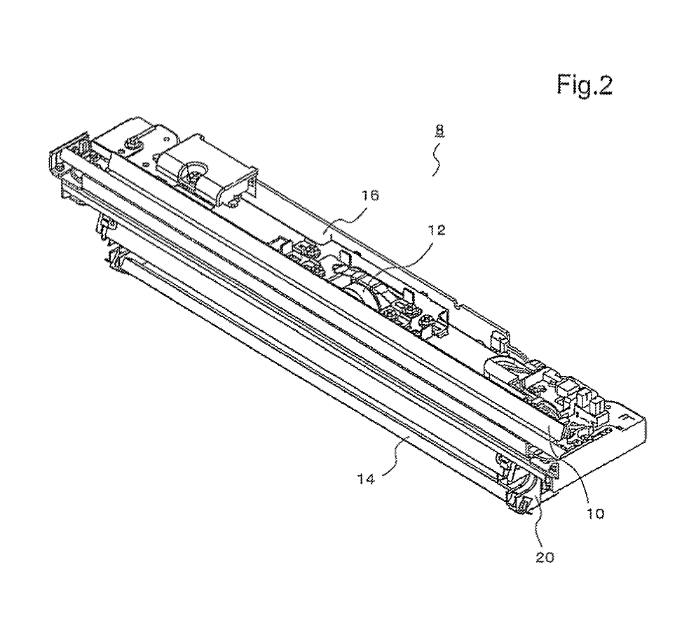

FIG. 2 is a perspective view of the optical unit 8. The optical unit 8 includes a light source 10, a lens 12, a mirror 14, a light receiving device 16 and a mirror support device 20 and the like. The light source 10 emits light to be applied to an original placed on the contact glass 6. The lens 12 performs concentration and the like of light reflected by an original by refracting it, and makes the concentrated light enter the light receiving device 16. The mirror 14 reflects light, and changes its optical path. The mirror support device 20 supports the mirror 14,

By the optical unit 8 being moved along the surface of the contact glass 6, light from the light source 10 is applied to an original placed on the contact glass 6. Reflected light from the original is led to the light receiving device 16 including a CCD (Charge Coupled Device) and the like via the mirror 14 and the lens 12. By this, an electric signal corresponding to the image of the original is outputted from the light receiving device 16 and image reading is performed.

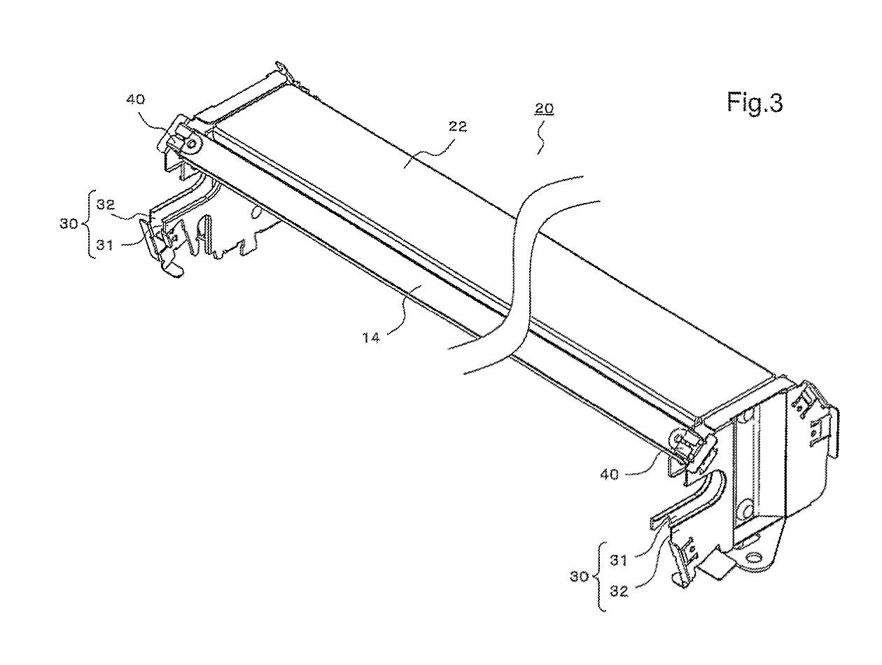

FIG. 3 is a perspective view of the mirror support device 20. The mirror support device 20 includes a main frame 22, a supporting plate 30 and a clip 40, and is formed by sheet metal. The mirror 14 arranged along the main frame 22 is inserted into the supporting plate 30, and is fixed by the clip 40. Meanwhile, the supporting plate 30 is formed by two side plates 31 and 32, and is provided in both ends of the main frame 22.

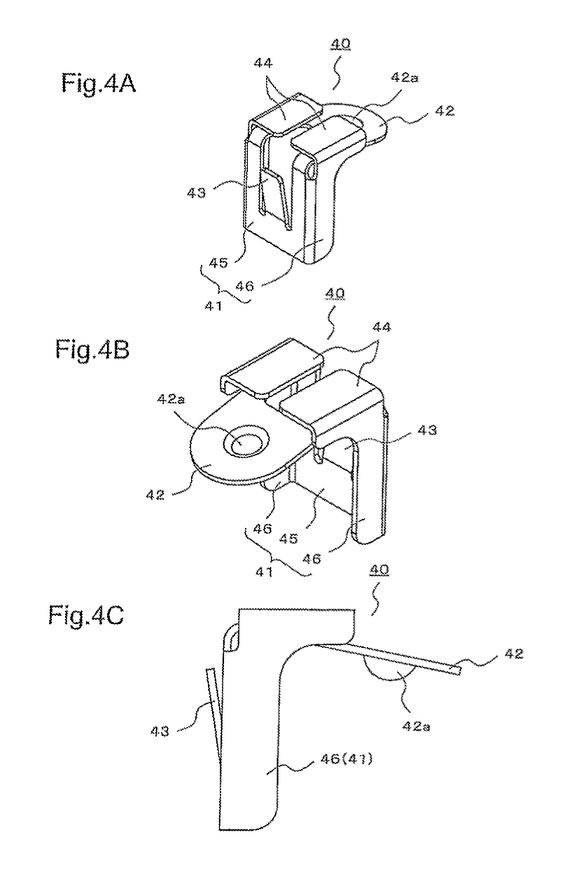

FIG. 4A is a perspective view seen from the back of the clip 40, and FIG. 4B is a perspective view seen from the front. FIG. 4C is a side view of the clip 40. The clip 40 has a leg part 41, a mirror suppressor plate 42, a locking plate 43 and cover plates 44 for covering the mirror suppressor plate 42, and is formed by sheet metal. Meanwhile, the mirror support device 20 and the clip 40 may be formed by resin.

The leg part 41 includes a back plate 45 and sleeve plates 46 formed by bending the both ends of the back plate 45. The mirror suppressor plate 42 is formed by bending the upper end of the back plate 45. In this mirror suppressor plate 42, a hemispheric mirror suppressing projection 42a is formed by press processing. The cover plates 44 are formed by bending the upper ends of the sleeve plates 46 such that the mirror suppressor plate 42 is wrapped around. Further, by cutting and raising the central part of the back plate 45, the locking plate 43 is formed.

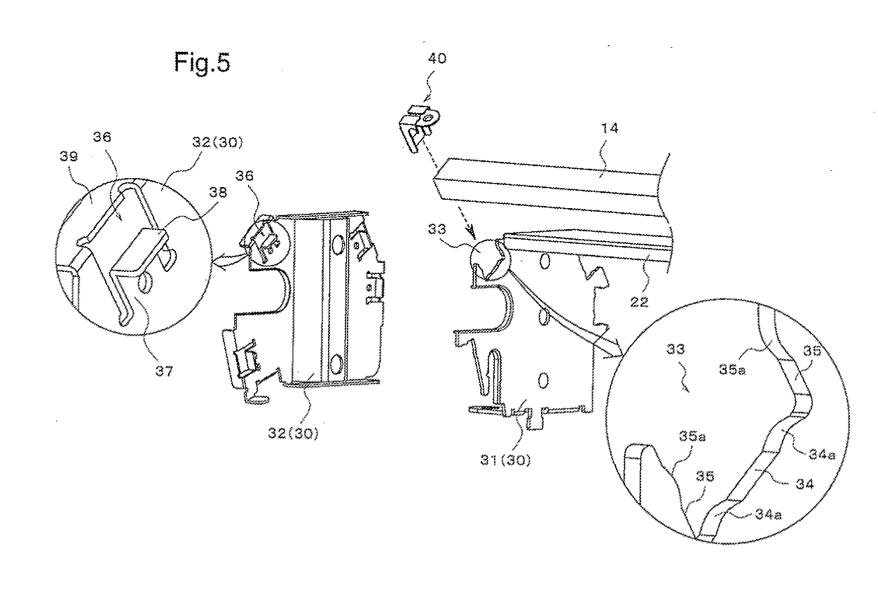

FIG. 5 is a fragmentary perspective view of the supporting plate 30. The supporting plate 30 is formed by caulking two side plates 31 and 32 together. Hereinafter, the side plate in the mirror 14 side is described as an inner side plate 31, and the side plate opposing the inner side plate 31 as an outer side plate 32. A mirror insertion opening 33 into which one of the left and right ends of the mirror 14 is inserted is formed in the inner side plate 31. The mirror insertion opening 33 includes a bottom wall 34 and two side walls 35 facing each other. Two bottom wall projections 34a are provided in the bottom wall 34, and one side wall projection 35b is provided in each of the side walls 35. The bottom wall projections 34a and the side wall projection 35b are projections which support the mirror 14. Because the mirror 14 is supported by the bottom wall projections 34a and the side wall projection 35b in this manner, the mirror 14 sits stably.

On the other hand, in the outer side plate 32, there are formed a clip hole 36 to which the leg part 41 of the clip 40 is inserted, a guide plate 37, a clip supporting plate 39 and a mirror stopper plate 38.

Next, the detailed composition and behavior of such mirror support device will be described along with an assembly work procedure. It is supposed that the mirror 14 exists in front of the worker on this occasion.

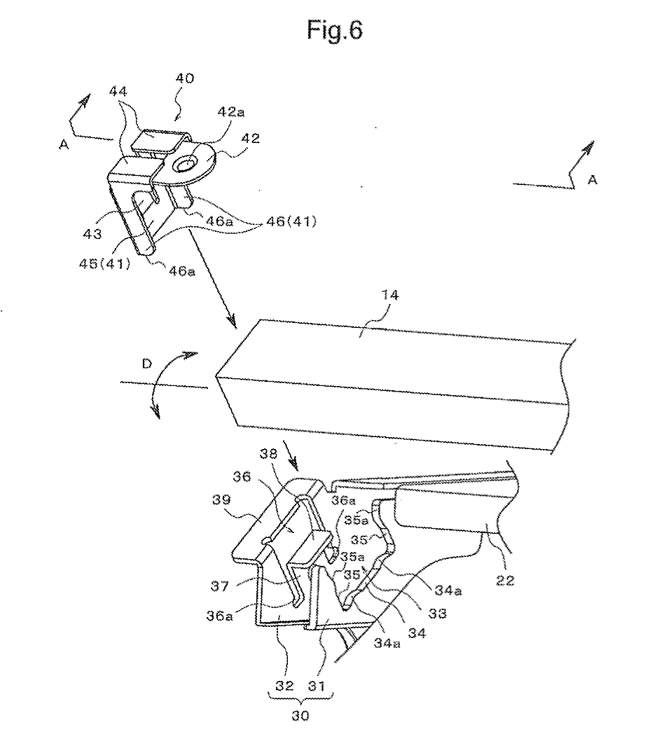

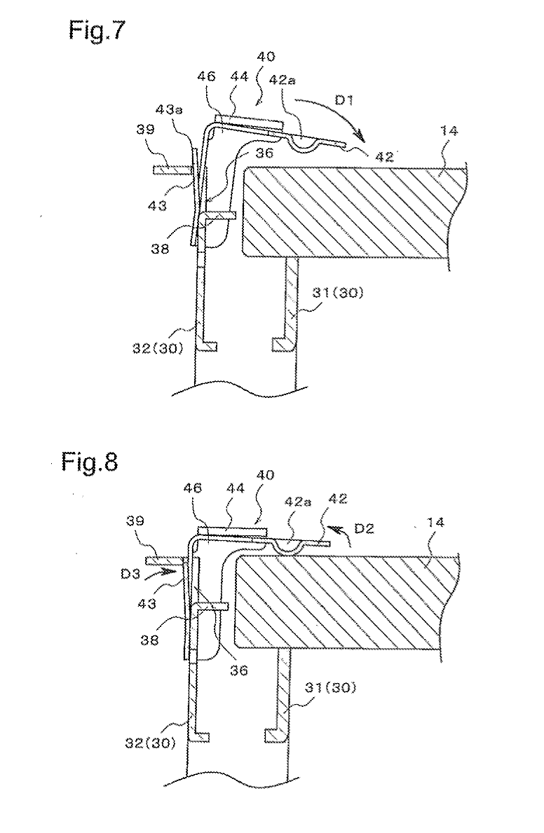

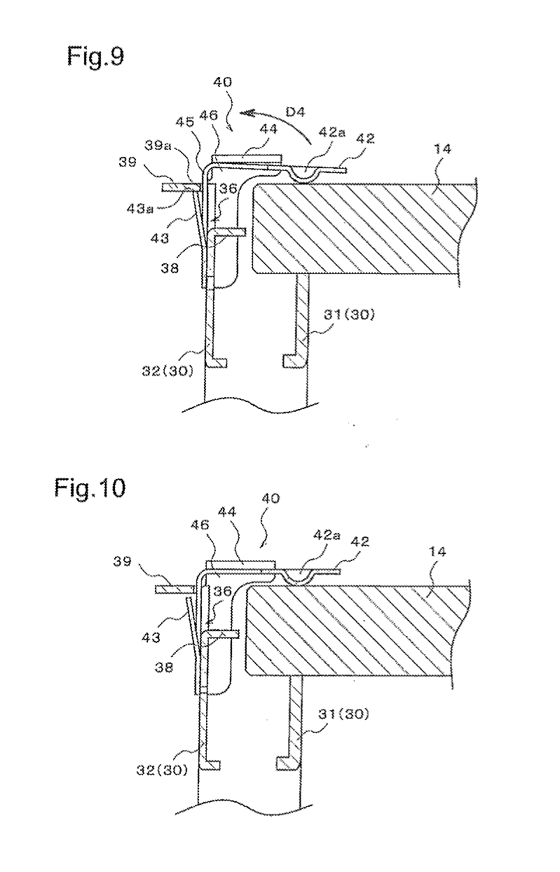

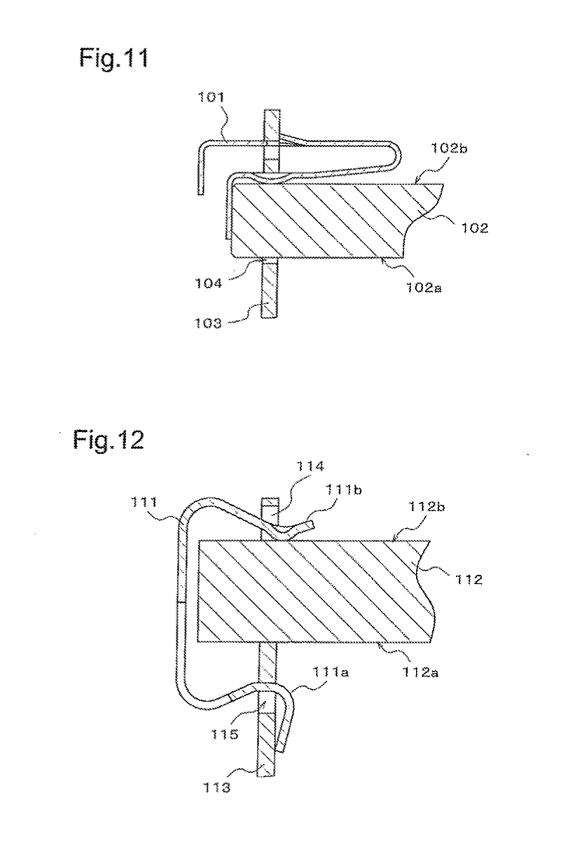

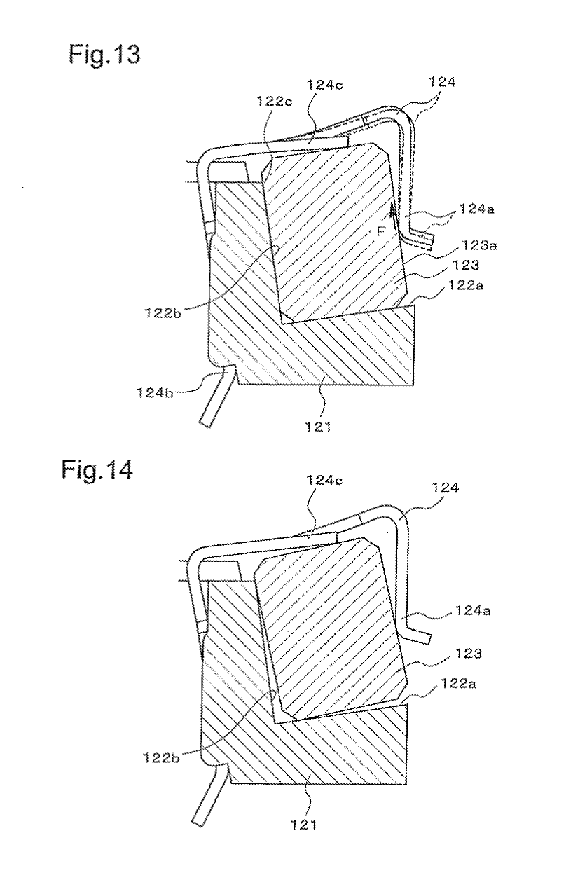

FIG. 6 is a fragmentary perspective view showing the state when beginning insertion of the mirror 14 into the supporting plate 30, and FIGS. 7-10 are sectional views showing an insertion procedure of the clip 40 and are sectional views taken along the line A-A of FIG. 6. Meanwhile, FIG. 7 shows a state at the time of beginning of insertion of the clip 40, and FIG. 8 indicates a state that the locking plate 43 is in contact with the clip supporting plate 39. Further, FIG. 9 indicates a state that the locking plate 43 is positioned in a portion lower than the clip supporting plate 39, and FIG. 10 shows a state that the clip is pushed to the maximum amount.

First, by moving the mirror 14 downward, each of the left and right ends of this mirror 14 is inserted into the mirror insertion opening 33 of the inner side plate 31. On this occasion, a lengthwise position of the mirror 14 is regulated by the position where an end faces 14a of the mirror 14 in the left and right sides hit the mirror stopper plate 38. That is, a left-right position of the mirror 14 is set automatically by a worker inserting the mirror 14 between the mirror stopper plate 38 in the left and that in the right.

When the mirror 14 is inserted into the mirror insertion opening 33, the mirror 14 comes into contact with the bottom wall projections 34a in the bottom wall 34 of the mirror insertion opening 33. The two bottom wall projections 34a are provided in the bottom wall 34, and the side wall projection 35a is provided in each of the side walls 35. The two bottom wall projections 34a are provided in positions distant from each other as far as possible. When the mirror 14 is in contact with the bottom wall projections 34a, a two-point support state is achieved. Because the mirror 14 is supported in this two-point support state, a turn in which an axis in the lengthwise direction of the mirror 14 is the rotating shaft (in FIG. 6, a turn in the direction of the arrow D) is regulated.

Next, the clip 40 is inserted. On this occasion, a worker inserts the clip 40 into the clip hole 36 without changing his/her posture. Accordingly, the mirror support work can be performed efficiently. When inserting the clip 40, it is pushed in while putting a thumb on the cover plates 44, for example. Because the cover plates 44 are provided in a manner to wrap the mirror suppressor plate 42, the thumb does not touch the mirror suppressor plate 42. Accordingly, there are no cases that the mirror suppressor plate 42 has a plastic deformation by the force when inserting the clip 40.

When inserting the clip 40, it is inserted in a manner that the guide plate 37 is wrapped by the leg part 41 consisting of the back plate 45 and the sleeve plates 46, and further inserted along the rear side (the surface in the side opposite to the mirror 14 side) of this guide plate 37 and fitted. That is, because the guide plate 37 functions as a guide during insertion of the clip 40, insertion work can be performed easily.

When insertion of the clip 40 is begun, the locking plate 43 of this clip 40 is in contact with the clip supporting plate 39 of the outer side plate 32, and as shown in FIG. 7, the clip 40 is tilted to the mirror 14 side. In FIG. 7, the tilting direction of the clip 40 is indicated by the arrow D1.

When insertion of the clip 40 is continued further, the mirror suppressing projection 42a of the mirror suppressor plate 42 comes into contact with the mirror 14 as shown in FIG. 8. In such state, the mirror suppressor plate 42 has an elastic deformation in a direction of the cover plates 44 side, and also the locking plate 43 has an elastic deformation in a direction of the mirror 14 side. In FIG. 8, the deformation direction of the mirror suppressor plate 42 is indicated by the arrow D2, and the deformation direction of the locking plate 43 by the arrow D3.

Then, as shown in FIG. 9, when an upper end 43a of the locking plate 43 is positioned in a position lower than the clip supporting plate 39, the locking plate 43 restores and is locked by the clip supporting plate 39. At that time, the clip 40 stands up by an elastic force of the mirror suppressor plate 42. In FIG. 9, the standing up direction of the clip 40 is indicated by the arrow D4.

When the clip 40 stands up, the back plate 45 is in contact an edge 39a of the clip supporting plate 39, and a stand operation of the clip 40 is regulated. At that time, the mirror suppressor plate 42 is in a state that it is not restored completely. Accordingly, the mirror 14 keeps being pushed towards the bottom wall projections 34a side. The locking plate 43 and the clip supporting plate 39 are engaged by face contact. That is, the upper end 43a of the locking plate 43 touches an under surface of the clip supporting plate 39. Thus, because the engagement is made by face contact, there are no cases that a clip tilts to a direction vertical to the sheet of FIG. 9. Accordingly, the mirror 14 is pressed stably. In an experiment using this method, a mirror was able to be held by a constant force of no smaller than 5 N, and, at the same time, it was possible to suppress a backlash of the mirror at that time to a level not more than 0.1 degree as an angle.

There might be a case where a worker continues insertion of the clip 40 without noticing that the locking plate 43 is locked by the clip supporting plate 39, reaching a state of FIG. 10. The state of FIG. 10 is a state that a lower end surface 46a of the sleeve plates 46 shown in FIG. 6 has come into contact with a lower end surface 36a of the clip hole 36. However, it is a state just before the upper surface of the mirror suppressor plate 42 touches the under surface of the cover plates 44. That is, the upper surface of the mirror suppressor plate 42 is not in contact with the under surface of the cover plates 44. By the lower end surface 46a of the sleeve plates 46 being in contact with the lower end surface 36a of the clip hole 36, insertion of the clip 40 is regulated, and thus the clip cannot be inserted any more. Accordingly, when insertion of the clip 40 is stopped, a worker can sense that the insertion work has been completed. Therefore, insertion work of the clip 40 can be performed easily.

When a worker releases his hand from the clip 40, the clip 40 returns to the state of FIG. 9 from the state of FIG. 10, and the locking plate 43 and the clip supporting plate 39 are engaged.

Meanwhile, although there may be concern that the mirror 14 moves when the clip 40 returns to the state of FIG. 9 from the state of FIG. 10, the mirror does not move because of the following reason. That is, the portion that is in contact with the mirror 14 directly is the mirror suppressing projection 42a of the mirror suppressor plate 42. Because this mirror suppressing projection 42a has a hemispherical shape, a load by the mirror suppressor plate 42 is added to the mirror 14 as a point load. The mirror suppressing projection 42a is located just above the bottom wall 34 of the mirror insertion opening 33. Accordingly, the action force at the time when the clip 40 returns to the state of FIG. 9 from the state of FIG. 10 always faces the bottom wall 34. Therefore, the mirror 14 does not move.

Meanwhile, when removing the clip 40 that has been thus inserted, the locking plate 43 is pressed to the mirror 14 side. As a result, by the force which the mirror suppressor plate 42 is pushing the mirror 14, the clip 40 is extracted. Accordingly, it is possible to remove the clip 40 easily without damaging the mirror 14 and the clip 40. Because the clip 40 and the mirror 14 are not damaged, their reuse becomes possible.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A mirror support device arranged in both ends of a stick-like mirror for holding the mirror, comprising:
an inner side plate, comprising a mirror insertion opening formed in the inner side plate, the mirror insertion opening for inserting an end of a mirror;
an outer side plate connected to the inner side plate, comprising: a mirror stopper plate for regulating positions of a right and a left end face of the mirror inserted into the mirror insertion opening; and a clip hole, the mirror stopper plate and the clip hole being formed in the outer side plate; and
a clip for fixing the mirror, the clip being inserted into the clip hole from a same direction as inserting direction of the mirror.

2. The mirror support device according to claim 1, wherein the clip comprises:
a leg part formed by a back plate and a sleeve part formed by bending a left and a right side end of the back plate, the leg part being inserted into the clip hole;
a mirror suppressor plate formed by bending an upper end of the back plate, the mirror suppressor plate pressing the mirror; and
a cover plate formed by bending an upper end of the sleeve part, the cover plate covering the mirror suppressor plate.

3. The mirror support device according to claim 2, wherein
the mirror suppressor plate is formed in a manner to form an acute angle with the back plate and is away from the cover plate by a predetermined amount.

4. The mirror support device according to claim 1, wherein
the outer side plate comprises a guide plate for guiding the clip inserted into the clip hole.

5. The mirror support device according to claim 4, wherein
the guide plate regulates a turn of the clip in a direction taking a longitudinal direction of the mirror as a rotating shaft.

6. The mirror support device according to claim 1, wherein
the outer side plate comprises a clip supporting plate which regulates tilting of the clip inserted into the clip hole in a direction away from the mirror.

7. The mirror support device according to claim 1, wherein
a locking plate for stopping the inserted clip from being pulled out by being engaged with the clip supporting plate is formed into the back plate by cutting and raising work.

8. The mirror support device according to claim 4, wherein
the mirror stopper plate is formed by bending an upper end of the guide plate.

9. The mirror support device according to claim 2, wherein
an insertion amount of the clip is regulated by a lower end surface of the sleeve part being in contact with a lower end surface of the clip hole.

10. The mirror support device according to claim 1, wherein
two bottom wall projections are formed in a bottom wall of the mirror insertion opening in a manner away from each other, and the mirror is point-supported by the two bottom wall projections.

11. The mirror support device according to claim 1, wherein
one side wall projection is formed in each of side walls of the mirror insertion opening opposing each other, and the mirror is point-supported by the side wall projections.

12. The mirror support device according to claim 10, wherein
a mirror suppressing projection projecting toward the mirror side is formed in the mirror suppressor plate and is formed in a position opposing an intermediate position between the neighboring bottom wall projections.

13. An image reader, comprising
a contact glass for placing an original; and
an optical unit comprising a mirror support device installed in a portion lower than the contact glass, wherein
the mirror support device comprises:
an inner side plate comprising a mirror insertion opening formed in the inner side plate, the mirror insertion opening for inserting an end of a mirror;
an outer side plate connected to the inner side plate, comprising: a mirror stopper plate for regulating positions of a right and a left end face of the mirror inserted into the mirror insertion opening; and a clip hole, the mirror stopper plate and the clip hole being formed in the outer side plate; and
a clip for fixing the mirror, the clip being inserted into the clip hole from a same direction as inserting direction of the mirror.
